(19) United States
(12) Patent Application Publication
(10) Pub. No.: US 2012/0178055 A1
(43) Pub. Date: Jul. 12, 2012

(54) COLOR SPOON

(76) Inventor: Michael Reyzis, Cleveland, OH (US)

(21) Appl. No.: 13/349,273

(22) Filed: Jan. 12, 2012

Related U.S. Application Data
(60) Provisional application No. 61/431,949, filed on Jan. 12, 2011.

(51) Int. Cl. G09B 19/00

(52) U.S. Cl. 434/100

(57) ABSTRACT

This application relates to a method of allowing customers to personally view cosmetic materials they located on the internet without leaving their homes and more particularly to a colored spoon.

### CROSS-REFERENCE TO RELATED APPLICATION

This application claims benefit from U.S. Provisional Patent Application No. 61/431,949, entitled “COLOR SPOON,” filed on Jan. 12, 2011, which is hereby incorporated by reference in its entirety.

### FIELD

This application relates to a method of allowing customers to personally view cosmetic materials they located on the internet without leaving their homes and more particularly to a colored spoon.

### BACKGROUND

In earlier days, consumers would go to a shopping mall or to a store and browse products they were looking to purchase. In the case of nail polish, they would often look at samples of the nail polish to ensure that it was the color they desired. The ability to look at the color of the nail polish with their own eyes, with the nail polish being used in a similar manner to how the consumer would use such a product, was invaluable to a consumer before making such a purchase. This left most consumers happy with the color of nail polish they purchased.

Today, more and more purchases, including nail polish, are occurring over the internet. This is because of the greater convenience purchasing products over the internet provides. However, one drawback of purchasing products over the internet, and especially nail polish, is that it can often be very difficult to clearly see what a product looks like. This is especially true with shades of colors, as the limited resolution of computer screens often blur and distort the actual shade of the color. This has often lead online consumers of nail polish to purchase colors thinking that they are getting the exact color they see on the screen, and then being disappointed by the actual color they receive when the product arrives. This has led to many unhappy customers who are receiving products they do not desire. The large amounts of unsatisfied customers lead to many returns, loss of future customers, loss profits and increased costs to the seller.

In addition, when viewing colors on a computer screen, a consumer is only viewing the color in a two-dimensional view, in a manner that is not similar to how that color will be used by the consumer. This also has led to many unhappy consumers who are disappointed by the color they receive when they finally view it in a three dimensions and use the product in a manner it was intended to be used.

The present invention provides a design that overcomes these challenges, including providing a method of allowing customers to personally view cosmetic samples of colors they located on the internet without having to leave their homes.

### BRIEF DESCRIPTION OF THE DRAWINGS

Embodiments of the present disclosure are described herein with reference to the drawings wherein:

FIG. 1 illustrates a screen shot of how the color segments are displayed;

FIG. 2 illustrates a top view of the color spoon; and

FIG. 3 illustrates a top view of the color plate.

### DETAILED DESCRIPTION OF THE PREFERRED EMBODIMENTS

Reference will now be made in detail to embodiments of the invention, examples of which are illustrated in the accompanying drawings. It is to be understood that other embodiments may be utilized and structural and functional changes may be made without departing from the respective scope of the invention.

The following is a method of relaying to consumers information about the color of goods sold. In particular nail polish, lip gloss, make-up, or any other cosmetic good. In general, the method comprises a consumer entering a website and viewing a webpage with all colors listed. The consumer then selects a color it desires and submits that information into the webpage. The consumer then enters in their personal information. The company then sends samples of the selected products and colors to the consumer. The samples may be obtained for a small price and that price may be used as a credit for a future purchase. The samples sent to the consumer may be color spoons 10 with end portions 12 that are colored with the selected color. This enables a consumer, without leaving their home, to view colors of nail polishes in person before they purchase them. This also enables a customer, without leaving their home, to not only inspect the actual color of a cosmetic material, but to also inspect the relation of the cosmetic material to a customer's skin tone.

A consumer may enter a website, such as, but not limited to, zoya.com. In one embodiment, the consumer may then proceed to a display by selecting an option group such as, but not limited to, nail polish, lip gloss or color spoons. After selecting an option group the consumer is then lead to a webpage 14 that shows multiple colors available in a display of color segments for the selected option group. In another embodiment, a consumer may select an option group such as, but not limited to, a product type, product name, seasonal collection, or color finder which then the colors of the cosmetics are shown in color segments on the webpage which then leads the consumer to a webpage 14 that shows multiple colors available in a display of color segments 26 for the selected option group.

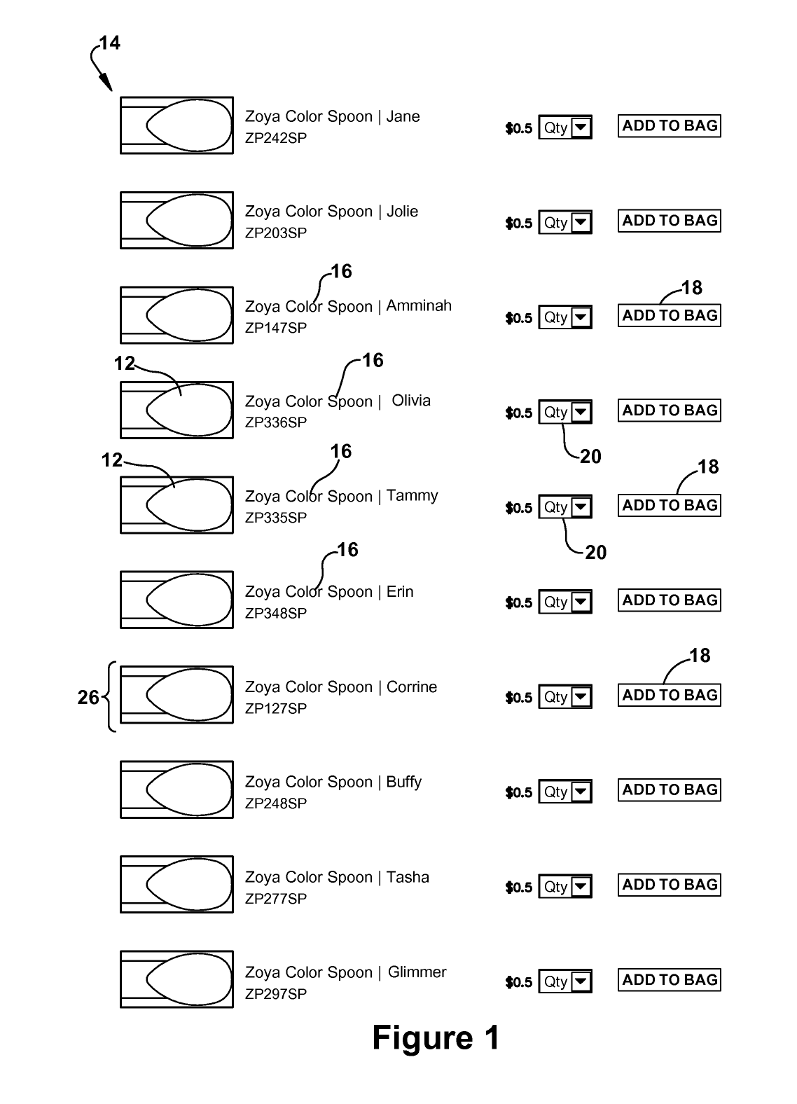

FIG. 1 shows one embodiment of how the color segments 26 may be displayed. The color segments 26 may be arranged in a variety of ways such as, but not limited to, color family, color shades, name, or number color. As shown in FIG. 1, the color segments 26 are aligned vertically in one column. However, the color segments 26 may be arranged in many fashions such as vertically in two or more columns or horizontally in one or more rows.

In one embodiment, the color segments 26 are arranged so that they are placed adjacently in order of color shades that are most similar. In one embodiment, a consumer may select a color from a color chart by clicking on a desired color link 16, typing in a desired color, or by any other means known for selection from a website. In one embodiment an “ADD TO BAG” 18 icon may be placed adjacent to each color segment 26. A consumer may then select that icon to indicate that is the color of the color spoon 12 they are interested in purchasing.

In one embodiment the consumer may then enter how many products he wishes to purchase. A quantity box 20 where the consumer may enter in the quantity of products he wishes to purchase may be labeled “Qty”, as shown in FIG. 1, but may also be labeled in any other manner. The number that may be entered into the quantity box 20 may be one or more. The number may be selected from a drop down box listing increasing numbers or may also be typed into the quantity box 20.

At some point, either before selecting the color or after selecting the color, a consumer may enter personal information into the website including, but not limited to, a mailing address, payment information, a login ID and corresponding password, email address, personal preferences, or any other information commonly entered into websites during purchases. Color spoons 10 or color plates 24 containing the color shades selected by the consumer are then shipped to the consumer's mailing address for the consumer to sample. In one embodiment the color spoons 10 or color plates 24 are shipped to the consumer at no cost of the consumer. However, in other embodiments the consumer may be charged partially or fully for shipping.

In one embodiment the consumer may be charged for each color spoon 10. In another embodiment the amount the consumer is charged for each color spoon 10 may be applied to any future purchase made on the website. This information may be stored on the website and may be saved to each consumer's personal login information. The information may also be stored in any other fashion known.

A color spoon 10 may be comprised of a plastic material or any other similar material. In one embodiment a color spoon 10 is substantially clear and may enable visible light to pass through.

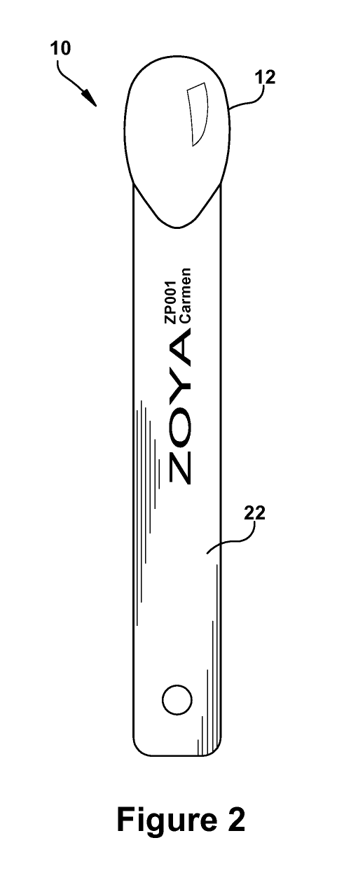

The single color spoon 10 may contain a handle 22 and an end portion 12 that is shaped substantially similar to a human finger nail. In one embodiment, the handle 22 may be narrower than the color spoon end portion 12, as shown in FIG. 2. The color spoon end portion 12 is shaped in a concave shape at the non-colored side. The non-concave area of the color spoon end portion may be coated with a particular shade of nail polish or any other cosmetic material. In one embodiment, a color spoon end portion 12 is coated with the actual color of a cosmetic material, not a color match.

The concave side may be placed over the consumer's fingernail to enable a consumer to see how a particular shade of nail polish would look on their fingernails. This enables a consumer to see if they like a particular shade of nail polish by enabling them to see the color directly, and over their fingernail, instead of through a computer screen. In addition, the shape of the color spoon end portion 12 enables a consumer to place a fingernail-like colored material over their own fingernail to sample the nail polish as close as they can without putting the nail polish on their own nails.

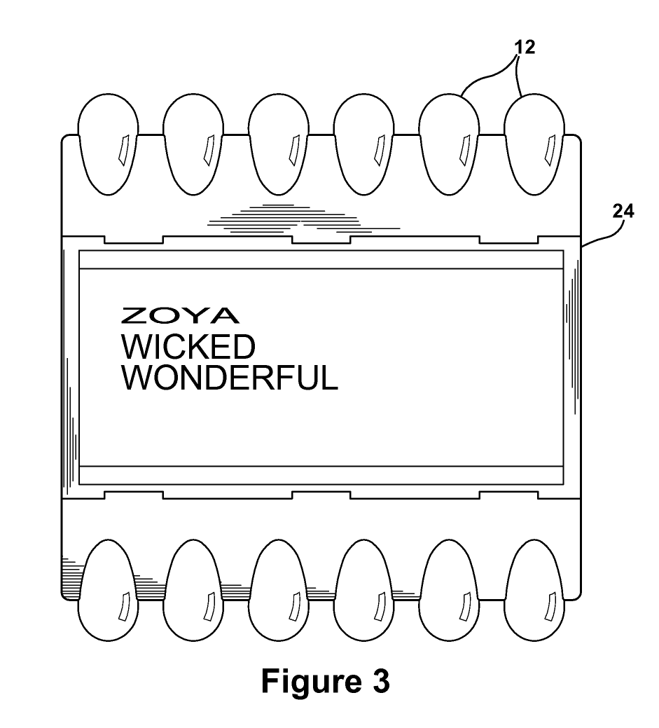

In one embodiment color spoon end portions 12 may be provided in color spoons 10 as shown in FIG. 2 or may be attached to a plate to form a color plate 24 as shown in FIG. 3. A color plate 24 may be comprised of plastic or any other similar material that may be used to make the color spoons. A color plate 24 may contain two or more color spoon end portions 12 on the perimeter of the plate. In one embodiment, the color plate 24 is of a rectangular shape with the color spoon end portions 12 being placed on opposite sides of the rectangular plate. In one embodiment, it is common for the color spoon end portions 12 to be placed on the longer end of the rectangular shaped color plate, although the color spoon end portions 12 could be placed at any location on the perimeter of the color plate 24.

The present invention provides a design that overcomes the many challenges associated with ordering cosmetics, in particular nail polish, on the internet which will lead to increased customer satisfaction.

Having thus described the invention, we claim:

1. A color spoon as substantially shown and described.

2. A color plate as substantially shown and described.

3. A method of allowing consumers to sample cosmetics as substantially shown and described.
